(19) United States
(12) Patent Application Publication
(10) Pub. No.: US 2004/0169579 A1
(43) Pub. Date: Sep. 2, 2004

(54) Temperature sensor and method for production thereof

(76) Inventors: Bernhard Mattes, Sachsenheim (DE); Pascal Kocher, Gerlingen (DE); Karl-Franz Reinhart, Weinsberg (DE); Thorsten Pannek, Stuttgart (DE); Rolf-Juergen Recknagel, Jena (DE); Rolf Aidam, Endingen (DE)

Correspondence Address: KENYON & KENYON, ONE BROADWAY, NEW YORK, NY, 10004, US

(21) Appl. No.: 10/481,287

(22) PCT Filed: Feb. 13, 2003
(86) PCT No.: PCT/DE03/00427

(30) Foreign Application Priority Data
Apr. 30, 2002 (DE) 102 19 247.2

(51) Int. Cl. H01C 7/10

(52) U.S. Cl. 338/25; 338/23

(57) ABSTRACT

A temperature sensor having sturdy construction is simple to install and to package, is uncomplicated to manufacture, and suitable for reliably detecting rapid temperature changes. The temperature sensor (1) includes a silicon substrate (2) in which at least one porous area (3) is formed, the degree of porosity and the thickness of the porous area (3) being chosen so that the porous area (3) is thermally isolated from the silicon substrate (2). In addition, the temperature sensor (1) includes temperature measuring elements (6, 7) for detecting the temperature difference between the silicon substrate (2) and the porous area (3). The temperature sensor may also include heating elements for testing the sensor function.

### BACKGROUND INFORMATION

The present invention relates to a temperature sensor which is conceived in particular for registering rapid temperature changes, and a method for manufacturing such a temperature sensor.

In German Patent Application 100 57 258, utilization of a temperature sensor is proposed in connection with the detection of side impacts in motor vehicles. To that end, the temperature sensor is placed in a side part of the motor vehicle that forms a largely closed hollow body. In the event of a side impact that is connected with deformation of the side part, there is generally an adiabatic pressure increase accompanied by an adiabatic, rapid temperature rise. Thus if the temperature sensor located in the side part detects a rapid temperature increase, this may be considered an indication of a side impact having occurred.

The device described in German Patent Application 100 57 258 for detecting side impacts includes a micromechanical temperature sensor having a thin membrane, formed in a silicon substrate. The membrane has significantly lower heat conductivity and thermal capacity than the silicon frame. The resulting temperature difference between the membrane and the silicon frame is detected with the help of temperature measuring elements in the form of appropriately positioned platinum resistors.

The known temperature sensor turns out to be problematic in many respects. The thermal isolation between the membrane and the silicon frame required for the function of the known temperature sensor necessitates a very small membrane thickness of around 1 to 5 μm. Accordingly, the membrane is highly subject to breaking, and the temperature sensor as a whole is mechanically unstable, so that the membrane may easily be broken for example even during installation of the temperature sensor, or even just when the corresponding side door of the motor vehicle is closed, thus causing the temperature sensor to fail. During installation and during packaging of the known temperature sensor, especially during adhesive bonding, care must also be taken to ensure that neither particles of dirt nor adhesive collect in the rear cavity beneath the membrane, in order to ensure thermal isolation between the membrane and the silicon frame. Finally, the silicon substrate for manufacturing the known temperature sensor must be processed micromechanically on both sides, which is relatively expensive.

### ADVANTAGES OF THE INVENTION

With the present invention, a temperature sensor with stable construction is proposed which is simple to install and package, uncomplicated to manufacture, and using which rapid temperature changes may be detected reliably.

The temperature sensor according to the present invention includes a silicon substrate in which at least one porous area is formed, the degree of porosity and the thickness of the porous area being chosen so that the porous area is thermally isolated from the silicon substrate. In addition, temperature measuring elements are provided for detecting the temperature difference between the silicon substrate and the porous area.

It has been recognized according to the present invention that the sensor principle of the known micromechanical temperature sensor—namely the implementation of a thermally isolated area in the silicon substrate of the temperature sensor—is also implementable by producing a porous area in the silicon substrate. The thermal resistance of such a porous area is significantly higher than that of the surrounding silicon substrate, by reason of the reduced mass and the nanostructure of the porous silicon in this area alone, so that the porous area and the silicon substrate are thermally isolated. Nevertheless, a silicon substrate in which a porous area is formed is significantly more stable than an unsupported membrane which is embedded in a silicon frame, which simplifies the installation and the packaging of the temperature sensor according to the present invention and also has a positive effect on its service life. Furthermore, the temperature sensor according to the present invention is insensitive to soiling, since there are no indentations, recesses, or cavities formed either in the surface of the silicon substrate or in the porous area in which interfering dirt particles could accumulate. In contrast to the known temperature sensor, manufacture of the temperature sensor according to the present invention requires processing of only one surface of the silicon substrate. As a result, the manufacture of the temperature sensor according to the present invention is also uncomplicated and economical.

There are various possibilities for implementing a temperature sensor according to the present invention.

In one variant that is relatively simple to manufacture, the porous area in the silicon substrate is made primarily of porous silicon. Because of the small crystallite size of the porous material, from a few nanometers to some hundreds of nanometers, and the reduced mass, the heat conductivity and thermal capacity of such a PorSi area are greatly reduced compared to the silicon substrate. In another advantageous variant, the porous area is made at least partially of silicon dioxide, produced by partial or complete oxidation of the porous silicon. The oxidation causes the porous area to be stabilized against the temperature balance of subsequent processes in conjunction with the manufacturing. In addition, the oxidation results in further reduction of the heat conductivity, and hence in better thermal isolation of the porous area from the silicon substrate.

The porosity of the porous area is advantageously at least 60%, in order to minimize the mass of the remaining porous silicon but ensure sufficient stability. In this case, the factor by which the heat conductivity of the porous area is reduced compared to the heat conductivity of the silicon substrate is around 100. The quality of the thermal isolation is also determined by the thickness of the porous area. Good results are achieved with a thickness from around 10 μm to 200 μm.

To manufacture a temperature sensor according to the present invention, at least one porous area must first be produced in the silicon substrate of the temperature sensor. Temperature measuring elements are then placed in the area of the silicon substrate and in the porous area, to detect the temperature difference between the silicon substrate and the porous area.

For the sake of simplicity of the procedure, it is advantageous to produce the porous area in an electrochemical etching process, in particular through electrochemical anodizing using a medium containing hydrofluoric acid as the etching solution. This produces a sponge-like, porous silicon structure with a large internal surface. The porous silicon thus produced also differs in its chemical and physical properties from the bulk silicon of the silicon substrate. For example, the reactivity of the porous silicon is significantly higher than that of bulk silicon, while the thermal capacity and heat conductivity of the porous silicon are significantly lower than those of bulk silicon.

The depth, i.e., thickness of the porous area is normally determined by the etching rate and the duration of the etching process. The structure and porosity of the porous silicon are determined primarily by the process parameters during anodizing, such as the current density and the composition of the hydrofluoric acid, and by the type and doping level of the silicon substrate.

An electrochemical etch stop or masking layers such as silicon nitride are usually used to produce a locally confined porous area in a silicon substrate. In an advantageous variant of the method according to the present invention, at least the main surface of the silicon substrate in which the porous area is to be produced is provided with an etching mask. The etching mask defines the area to be etched, or the lateral dimensions of the area to be etched, although it must be kept in mind that electrochemical anodizing is a largely isotropic etching procedure in which the etching mask is undercut laterally. It is possible to use for example a metal mask, n+doping, a SiₓN_{y} layer, or a combination of n⁺ doping and a SiₓN_{y} layer as the etching mask. As mentioned earlier, the porous silicon produced in this way may subsequently be oxidized, which is favored by the increased reactivity of the porous silicon.

Advantageously, the porous area is protected against later environmental influences by a non-permeable protective coating. Suitable for this purpose are for example SiₓN_{y} or polysilicon coatings, which are easily produced using a CVD (chemical vapor deposition) process. When semiconductive protective coatings are used, an insulating layer of a material such as SiOₓ is also applied.

The temperature measuring elements of the temperature sensor according to the present invention are implemented in simple technical processes in the form of resistors or printed conductors, by applying and structuring conductive or semiconductive material on the silicon substrate and the porous area by CVD or sputtering. Heating elements to heat the porous area may also be produced in this way. The functionality of the temperature sensor may then be tested easily by artificially heating the porous area.

### DRAWING

As discussed in detail earlier, there are various possibilities for shaping and refining the teaching of the present invention in an advantageous way. To that end, reference is made to the claims subordinate to claim 1 and to the following description of several exemplary embodiments of the present invention on the basis of the drawing.

FIG. 1 shows a sectional view of a temperature sensor according to the present invention.

FIG. 2 shows the top view of another temperature sensor according to the present invention.

FIG. 3 shows the top view of a third temperature sensor according to the present invention.

### DESCRIPTION OF THE EXEMPLARY EMBODIMENTS

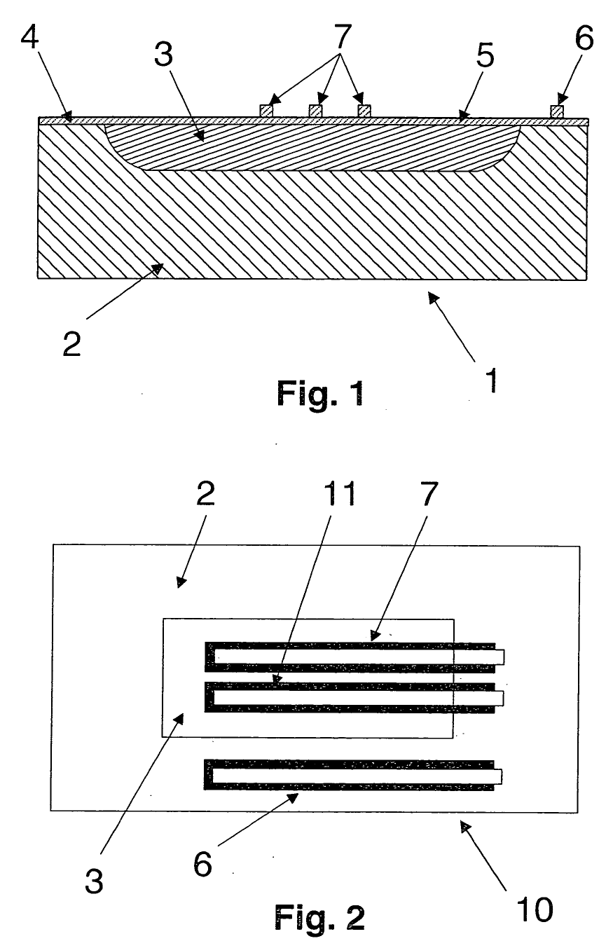

Temperature sensor 1 depicted in FIG. 1 includes a silicon substrate 2, in which a porous area 3 is formed. Porous area 3 adjoins a main surface 4 of silicon substrate 2. According to the present invention, the degree of porosity and the thickness of porous area 3 are chosen so that porous area 3 is thermally isolated from silicon substrate 2.

In the exemplary embodiment depicted here, the porous area is made primarily of porous silicon dioxide that was produced by electrochemical anodizing of silicon substrate 2 and subsequent oxidation. The porous area has a porosity of at least 60% and a thickness ranging from around 10 μm to 200 μm.

In addition, in the exemplary embodiment depicted here a protective coating 5 of SiₓN_{y} that is intended to protect temperature sensor 1 and in particular porous area 3 from later environmental influences is deposited on main surface 4 of silicon substrate 2.

Integrated on porous area 3 and on silicon substrate 2 are temperature measuring elements 6 and 7, using which it is possible to detect the temperature difference between silicon substrate 2 and porous area 3. In the exemplary embodiment depicted here, these are platinum resistors. However, temperature measuring elements 6 and 7 may also be made from other metallic materials such as aluminum or titanium, or from semiconductive materials such as doped silicon or silicon-germanium.

FIG. 2 shows a possible arrangement for temperature measuring elements 6 and 7 in the area of silicon substrate 2 (temperature measuring element 6) and in porous area 3 (temperature measuring element 7).

Temperature sensor 10, depicted in FIG. 2, has in addition a heating medium in the form of a heating resistor 11, which is also positioned in porous area 3. Heating resistor 11 is used to artificially warm porous area 3, which makes it simple to check the functionality of temperature sensor 10. Heating resistor 11 may also be implemented as a platinum resistor or be made of some other metallic or semiconductive material.

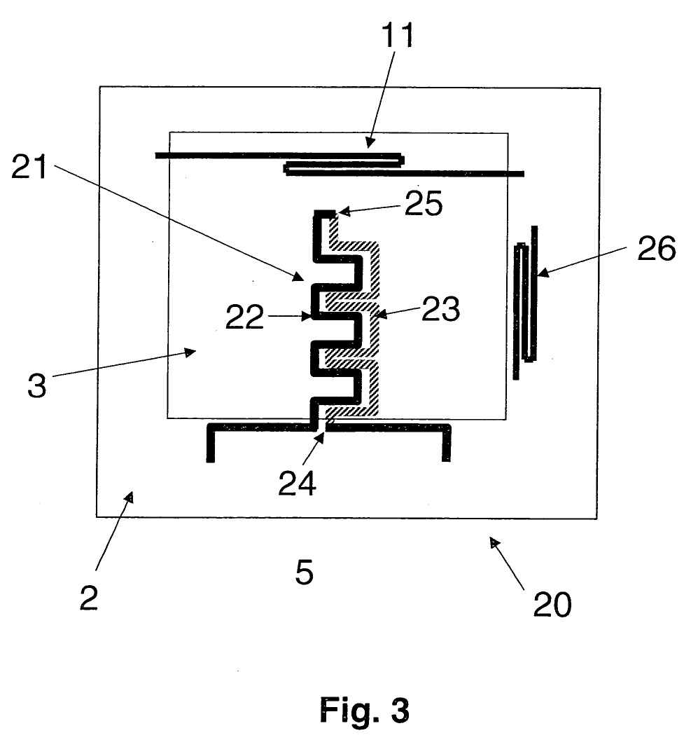

In the variant of a temperature sensor 20 according to the present invention depicted in FIG. 3, the temperature measuring elements are implemented not in the form of resistors, but in the form of a thermal chain 21. Thermal chain 21 includes two printed conductors 22 and 23 of different materials. The two printed conductors 22 and 23 are connected with each other at two contact points 24 and 25. The first contact point 24 is in the area of the “cold” silicon substrate 2, while the other contact point 25 is located in the “hot” porous area 3. Because of the thermoelectric effect, a temperature difference between silicon substrate 2 and porous area 3 produces a thermoelectric voltage between the two printed conductors 22 and 23. To increase the signal deviation, it is also possible to connect a plurality of thermal chains of different materials in series.

Printed conductors 22 and 23 of thermal chain 21 may likewise be made of metallic materials such as platinum, aluminum or titanium, or of semiconductive materials such as doped silicon or silicon-germanium.

Temperature sensor 20 also includes an additional temperature measuring element 26 located in the area of silicon substrate 2, and a heating resistor 11 located in porous area 3.

It should be pointed out here that porous or oxidized porous areas of almost any geometric shape may be produced by suitably masking the silicon substrate during electrochemical anodizing, because of the isotropic etching behavior.

With the help of the temperature sensors described above, it is possible in particular to detect even rapid temperature changes. Because of their insensitivity and their sturdy construction, they are particularly suited for use in motor vehicles, for example in connection with side impact detection, as explained in the preamble on the basis of the related art.

What is claimed is:

1. A temperature sensor
having a silicon substrate (2) in which at least one porous area (3) is formed, the degree of porosity and the thickness of the porous area (3) being chosen so that the porous area (3) is thermally isolated from the silicon substrate (2), and
having temperature measuring elements (6, 7) for detecting the temperature difference between the silicon substrate (2) and the porous area (3).

2. The temperature sensor as recited in claim 1,
wherein the porous area is made up primarily of porous silicon.

3. The temperature sensor as recited in claim 1,
wherein the porous area (3) is made at least partially of silicon dioxide.

4. The temperature sensor as recited in one of claims 1 through 3,
wherein the porous area (3) has a porosity of at least 60%.

5. The temperature sensor as recited in one of claims 1 through 4,
wherein the porous area (3) has a thickness of approximately 10 μm to 200 μm.

6. The temperature sensor as recited in one of claims 1 through 5,
wherein the porous area (3) adjoins a main surface (4) of the silicon substrate (2), and at least one protective layer (5), in particular a protective layer (5) of SiₓN_{y}, is formed at least over the porous area (3).

7. The temperature sensor as recited in one of claims 1 through 6,
wherein heating elements (11) are provided for heating the porous area and for testing the sensor function.

8. The temperature sensor as recited in one of claims 1 through 7,
wherein the temperature measuring elements (6, 7) and/or the heating elements (11) are realized in the form of resistors, which—depending on their function—are located in the area of the silicon substrate (2) and/or in the porous area (3).

9. The temperature sensor as recited in claim 8,
wherein the resistors (6, 7) are made of metallic materials, in particular of platinum, aluminum, or titanium.

10. The temperature sensor as recited in claim 8,
wherein the resistors are made of semiconductive materials, in particular of doped silicon or silicon-germanium.

11. The temperature sensor as recited in one of claims 1 through 7,
wherein the temperature measuring elements are realized in the form of at least one thermal chain (21), each thermal chain (21) including two printed conductors (22, 23) of different materials that are connected to one another at two contact points (24, 25), the one contact point (24) being located in the area of the silicon substrate (2) and the other contact point (25) being located in the porous area (3).

12. The temperature sensor as recited in claim 11,
wherein the printed conductors of the thermal chain are made of metallic materials, in particular of platinum, aluminum, or titanium.

13. The temperature sensor as recited in claim 11,
wherein the printed conductors of the thermal chain are made of semiconductive materials, in particular of doped silicon or silicon-germanium.

14. A method of producing a temperature sensor having a silicon substrate, in particular as recited in one of claims 1 through 13,
wherein at least one porous area is produced in the silicon substrate, and temperature measuring elements for measuring the temperature difference between the silicon substrate and the porous area are placed in the area of the silicon substrate and in the porous area.

15. The method as recited in claim 14,
wherein the porous area is produced in an electrochemical etching process, in particular through electrochemical anodizing using a medium containing hydrofluoric acid as the etching solution.

16. The method as recited in one of claims 14 or 15,
wherein an etching mask is produced on at least one main surface of the silicon substrate, whereby the area to be etched is defined, in particular a metal mask, an n⁺ doping, an SiₓN_{y} layer, or a combination of n⁺ doping and a SiₓN_{y} layer being used as the etching mask.

17. The method as recited in one of claims 15 or 16,
wherein the porosity produced in the etching process is determined by the doping of the silicon substrate, by the concentration of the etching solution, and/or by the current density applied during the etching process.

18. The method as recited in one of claims 15 through 17,
wherein the depth of the porous area is determined by the duration of the etching process.

19. The method as recited in one of claims 14 through 18,
wherein the porous silicon produced in the porous area is at least partially oxidized.

20. The method as recited in one of claims 14 through 19,
wherein at least one protective layer is produced over the porous area, in particular using a CVD (chemical vapor deposition) method.

21. The method as recited in one of claims 14 through 20,
wherein resistors and/or printed conductors are produced in the area of the silicon substrate and/or in the porous area by applying and structuring CVD and/or sputtered layers.

22. Use of a temperature sensor as recited in one of claims 1 through 13 in connection with a motor vehicle.

23. The use as recited in claim 22 for detecting a side impact, the temperature sensor being placed in a side part of the motor vehicle which forms a largely closed hollow body, to detect the adiabatic temperature rise in the event of a side impact.
